(19) United States
(12) Patent Application Publication
(10) Pub. No.: US 2007/0208596 A1
(43) Pub. Date: Sep. 6, 2007

(54) Service module in clinical workflow simulation tool for healthcare institutions

(75) Inventors: Marc Meiner, Ostheim/Rhon (DE); Stefan Scholl, Nuemberg (DE)

Correspondence Address: BRINKS HOFER GILSON & LIONE, P.O. BOX 10395, CHICAGO, IL, 60610, US

(73) Assignee: Siemens Aktiengesellschaft

(21) Appl. No.: 11/796,524

(22) Filed: Apr. 27, 2007

Related U.S. Application Data
(63) Continuation of application No. 11/363,919, filed on Feb. 28, 2006.

(51) Int. Cl. G06Q 10/00; G06G 7/48; G06F 3/048

(52) U.S. Cl. 705/2; 703/6; 715/848

(57) ABSTRACT

A service module for use in method for simulation of a clinical workflow in a healthcare facility which models the processes and treatment of patients is described. Each service has a module name and duration and is associated with data representing required resources such as rooms, personnel, equipment, consumables, workplace and the presence of the patient. The service module furnishes a definition of the resources associated with a specific service and provides the requested data to a module in a simulation, such as a device manager, an inventory manager or a scheduling manager.

The present application is related to U.S. application Ser. No. 11/363,919, filed on Feb. 28, 2006, and U.S. application Ser. No. ______, filed on Apr. 27, 2007, client matter number 2006P15921US (11371/142), by the same inventors.

### TECHNICAL FIELD

The present application relates to a service module in a workflow simulation and in particular to a method for simulating workflow in a healthcare institution.

### BACKGROUND

The healthcare industry is under considerable pressure to improve performance and to reduce costs. The healthcare facilities must be always be mindful of costs, resource utilization, timeliness of care, and efficiency of processes. In order to address issues in this area, consultants are generally hired to work with a healthcare facility to improve specific situations at the facility. Based on individual and facility specific workflow analysis, proposals for improvement are presented to the facility as a typical result of the project. The consulting project requires highly skilled people with process and medical knowledge and specific tools in order to accomplish the desired goals. The impact of changes in the processes and in the workflow on the operational and financial state of the healthcare facility is often based on an estimation utilizing standard parameters such as reimbursements rates, human resource costs, equipment and material costs, maintenance costs and the like, which are not considered as a dynamic interaction between different processes and workflows.

A healthcare facility needs a method and tool to provide a measure of a proposed change in a clinical workflow process before investing in infrastructure and re-engineering of processes. Fast, reliable, imaging diagnosis and suitable treatment for emergency and trauma patients is still among the major logistical challenges for the clinical environment.

A Clinical Workflow Simulation Tool and Method (CWST) has been described in U.S. application Ser. No. 11/363,919 filed on Feb. 28, 2006, by the present inventors, which is incorporated herein by reference. Different modules are needed to operate the CWST

### SUMMARY

A service module for a workflow simulation tool for a healthcare facility is described, including software stored on a computer readable medium and operable on a computer to provide a user interface for entering data defining the parameters and states of an object representing resources in a health care facility. The object represents a process step in a workflow used in simulation.

A method for using a service module in workflow simulation in a healthcare facility is described, including the steps of inputting data characterizing a service, the data including a name of the service, duration of the service, priority of the service, and resources required; storing the data in a memory; and providing the data to a requesting module in a workflow simulation.

### BRIEF DESCRIPTION OF THE DRAWINGS

FIG. 1(A, B) is a chart illustrating steps in workflow example for a patient with an acute myocardial infarction;

FIG. 2(A, B) is a chart illustrating workflow modules assigned to the workflow steps;

FIG. 3 is a “screen shot” showing a top-level view of the graphical user interface (GUI) of a service module;

FIG. 4 shows the service definition tab pane of the service module;

FIG. 5 shows a GUI representation of adding a service definition;

FIG. 6 shows a GUI representation of editing the attributes of, or removing a service definition in a service module;

FIG. 7 shows a dialog box for editing the attributes of a service definition;

FIG. 8 shows a representation of the rooms associated with a selected service;

FIG. 9 shows a short summary of the resource descriptor, including state information;

FIG. 10 shows a representation of the “arrange” function;

FIG. 11 shows a dialog box for adjusting the time of use of a resource using the arrange function;

FIG. 12 shows the use of the time of use adjustment for using rooms in series, parallel or series-parallel;

FIG. 13 shows a dialog box for defining resources;

FIG. 14 shows a room resource having a parent-child relationship;

FIG. 15 shows the resources associated with an example room, including personnel and devices; and

FIG. 16 shows a GUI screen shot of an information screen; and

FIG. 17(A, B) shows the correspondence between the modules of FIGS. 1 and 2 and a workflow process simulation.

### DETAILED DESCRIPTION

Exemplary embodiments may be better understood with reference to the drawings. Like numbered elements in the same or different drawings perform equivalent functions.

A clinical workflow simulation tool (CWST) may be thought of as a component of an overall construct called a CPRM (Customer Process Reference Model). The CPRM may consist of at least four levels. Level 1 may be the overall business processes of the health care facility (e.g., patient process, supply chain process, and the like). Level 2 may be seen as medical functional categorization (e.g., Diagnosis, Treatment, Discharge, and the like). Level 3 may be seen as medical paths (e.g., Lab tests, Non-Invasive Imaging, Invasive Procedures inside an operating theater, and the like). Level 4 may be seen as the workflow level, which describes the steps needed to perform a Level 3 building block path (e.g. what may be done inside a specific path, such as a MR-Head-Diagnosis). Lower levels of the CPRM model may include the simulation activities needed to optimize performance and these may be addressed by a CWST.

A service module for a method and tool for simulation of clinical workflow in a healthcare facility in order to quantify specific facility processes and workflows is described. Measures of operational and financial parameters are obtained and the operational and financial parameters are compared both before and after proposed changes in the processes and workflows. In order to input the data into the method and tool, the input information is obtained much the same way as with consulting projects for a healthcare facility. In particular, specific questions are raised such as, “what are the costs of clinical services such as operating rooms or stroke units”, “what are the benchmarks to compare these costs with,” “what are the actions and changes that should be implemented”, and “what are the consequences of these changes”. With these questions, parameters are defined such as costs per case, utilization rate for the operating theater, the number of nurses per case, the time for specific procedures, the patient transportation times, and the like. The data for the specific healthcare facility environment is measured. Examples of the measurements include that an analysis of the cost structure for the facility, a count of how many cases are handled in a specific area or during specific period of time, the number of nurses compared to the number of cases in specific time periods, how long a specific procedure runs in a specific time period, how long it takes for transportation of a patient from one point to another, etc.

The gathering of data is by answering the questions raised and defining and measuring the parameters which affect that question. Other data gathering is also possible. In order to implement the present method, specific data may be needed, such as measurements of the times needed for a nurse or a physician or technician to go to from one point to the next at the health care facility. The patient preparation time is determined, the day and night shift timed differences are determined, and the hospital layout is input. The data is gathered by conducting measurements in the healthcare facility environment during real world operations, for example, by either an outside consultant or by dedicated data gathering personnel. This type of data is not typically used in a consulting project but is utilized according to the present simulation tool.

The data input portion of the method may utilize a map to process the input into the system in order to map the client hospital or health care facility layout to the processes and assign resources to the process steps as well as to give time periods for the process steps, assign work places to the process steps, assign patients to the process steps, and define the interferences in the process.

In one embodiment, the simulation tool is a software program or set of programs that is operable on a computer and that is stored on computer readable media. The computer or computer system accepts inputs and performs the simulation and provides outputs by standard computer hardware, display devices, and software. The computer may be a stand-alone computer or may be connected to a network. More than one computer may be used, with different functions being performed by different computers.

In an embodiment, the clinical workflow simulation tool and method provides, for example, patient and client processes along with resource lists of human, technical and infrastructure resources, information on worker shifts, costs of defined resources, capacities for the resources, interferences between the processes, and resources at the specific healthcare facility user interface.

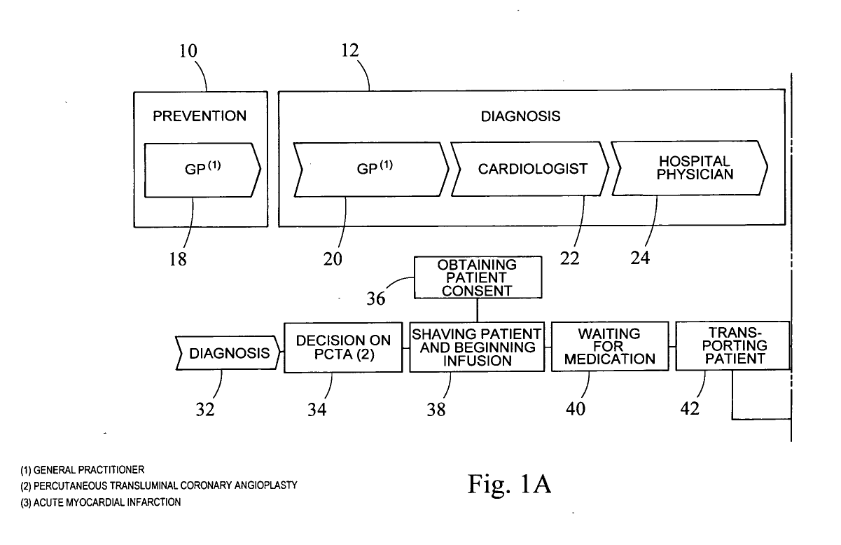

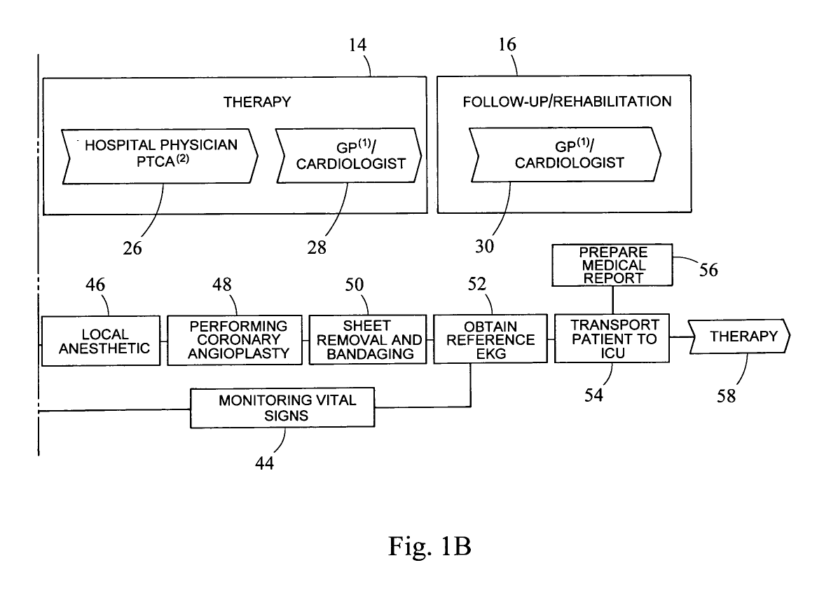

The collected data may be used to generate a clinical workflow as shown in FIG. 1. The clinical workflow illustrates the workflow processes for a healthcare facility for a patient with acute myocardial infarction (AMI) who is to be treated by percutaneous transluminal coronary angioplasty (PTCA). The upper portion of the illustration shows the major stages of the process including prevention 10, diagnosis 12, therapy 14, and follow-up and rehabilitation 16. The personnel who oversee processing in each major stage are indicated in each stage block. For instance, the prevention stage 10 is carried out under the authority of the general practitioner, indicated as GP in the drawing. The diagnosis stage 12 begins with the general practitioner at 20, consultation is carried out with a cardiologist at 22 and then the matter is referred to a hospital physician at 24. The therapy stage 14 is initiated by the hospital physician who carries out the PCTA and following the PCTA procedure the patient responsibility is transferred to the general practitioner or cardiologist or at least consultation is carried out with these doctors at 28. The follow-up and rehabilitation stage 16 is the responsibility of the general practitioner and cardiologist at 30.

The illustrated stages include process steps for each of the steps in the main process stages. For example, the therapy stage 14 by the hospital physician who performs the angioplasty includes the steps indicated in the lower portion of FIG. 1 wherein the therapy stage is begun with diagnosis 32, followed by a decision to perform the percutaneous transluminal coronary angioplasty (PCTA) at 34. This is followed by providing information to the patient and obtaining patient consent at 36 and installation of an intravenous line, shaving the patient and beginning infusion at 38. Thereafter, a step of waiting and pre-medication 40 is an element to be considered in the process. The patient is then transported to the cathlab (catheter laboratory) at 42. At this time, there may be continuous monitoring of vital signs as indicated at 44. Once in the cathlab, a local anesthesia is applied at 46, and the percutaneous transluminal coronary angioplasty is performed at 48. Following the angioplasty procedure, the operating sheets or drapes are removed and the patient is bandaged at 50. A reference EKG (electrocardiogram) is then taken at 52. Following the EKG, the vital signs monitoring 44 is discontinued. The conclusion of this stage of the therapy includes the transportation of the patient to the intensive care unit (ICU) at 54 and preparation of a medical report at 56. The therapy then continues as indicated at 58.

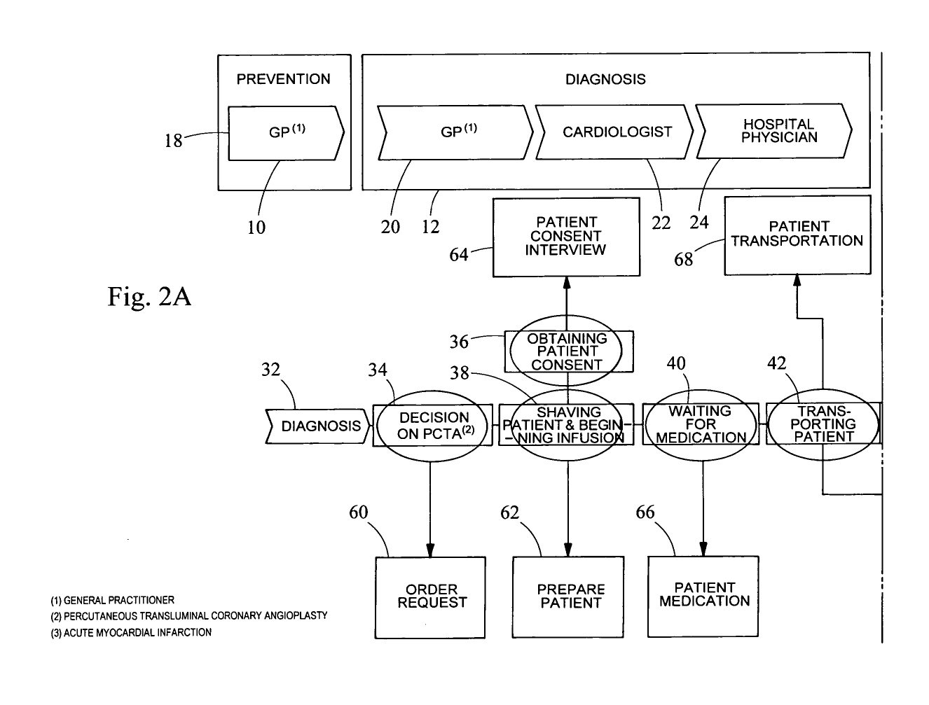

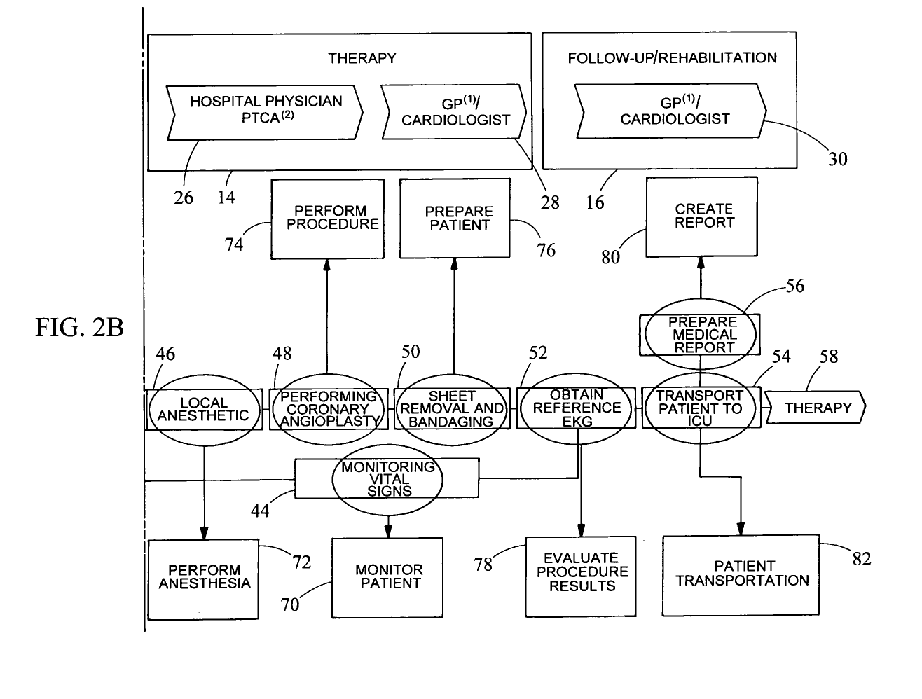

With reference to FIG. 2, the patient treatment steps may be clustered in modules. Each module is a step in the clinical patient workflow. In FIG. 2, the primary stages 10-16 are identical to those of FIG. 1. The steps performed under the authority of the hospital physician PTCA part are indicated in the lower portion of FIG. 2. For example, the decision to perform the PTCA 34 is allocated to an order request module 60. The intravenous line insertion, shaving of the patient, and infusion of intravenous fluids at step 38 is allocated to prepare the patient module 62. Substantially simultaneously thereto, the inform the patient and patient consent step 36 has allocated to it a patient interview consent module 64. The waiting and pre-medication step 40 has a patient medication module 66 allocated to it. The transport to cathlab step 42 has allocated to it a patient transportation module 68. The vital signs monitoring steps 44 has a monitor the patient module 70 allocated to it. The local anesthesia step 46 includes a module to perform the anesthesia at 72. The PTCA step 48 includes performing the procedure module at 74. The sheet removal and bandaging step 50 includes preparing the patient module 76. In the reference EKG step 52 an evaluate procedure results module 78 is provided. The medical report step 56 includes report creating module 80 while the transport to intensive care unit step 54 includes a patient transport module 82, which may be the same or a similar module as the patient transport module 68.

Modules of the clinical workflow may also interact with the resources available in the health care facilities. As such resources are finite and the demand for resources may conflict during a particular period of time, for workflows associated with the same or differing procedures, another module which may be used in the CWST is a “service module.” A service module represents a typical service or procedure relating to a patient, where the resources and materials are those nominally expected during the performance of the procedure or service. A service module may be parameterized to particularize the service or procedure to be performed. The resources scheduled to be used in performing the service or procedure are components of the service module parameters. Each resource may have specific attributes used in the service module parameterization.

The process of filling in the values for parameters of a resource is called instantiating the resource, and a resource which has all of its parameters filled in may be called a resource instance. The resource instance is the resource is described by the parameters allocated to the resource. By interacting with other modules which may create pools of specific types of resources, such as devices, personnel by skill, and the like, the finite nature of the resources may be introduced into the model and simulation.

In an aspect, a service may be defined by a set of parameters such as:
Name of the service;
Time period of the service;
Time interval before the start of the service where the patient is present;
Priority of the services; and
Resource required, including description of location, time of service and duration of service.

As an example, the resources may be associated as clusters exhibiting related attributes. In an aspect, such a clustering of attributes may lead to a definition of resources as:
Cluster 0: rooms;
Cluster 1: personnel;
Cluster 2: equipment;
Cluster 3: consumable supplies;
Cluster 4: patient;
Cluster 5: workplace or location;
Cluster 6: carrier (e.g., wheelchair, gurney, bed, or none (ambulatory));
Cluster 7: synchronizer (team-resources, e.g. OP-Team-1); and
Cluster 8: information systems.

The service module has a number of functions, including: the access to and storing of a description of the service, and accessing or being accessed by other service modules in the simulation environment.

The access and storing of a description of the service may include determining if the requested service is a known service, determining such attributes of the service as time of service and priority of service, the number of rooms needed to perform the service and the resources associated with each room. A complete description of the required resources and the attributes of all of the resources may be obtained to provide for instantiating of the service module for the specified service. The service module “delivers” its stored definitions to other modules (e.g. scheduling module) to enable them to perform their specific functionality.

The time of initiating the service may be considered an appointment time, and may depend on clinical issues. Commonly, an appointment in a clinical environment is a time at which the patient should be present in the treatment unit or room for performance of the service. Resource planning for providing the service is based on years of experience; however, this experience may need to be defined and quantified in a standardized manner so as to improve automated scheduling or to be used in simulations.

In an example, a service module is described using display “screen shots” of a graphical user interface (GUI) to illustrate the functionality the service module within CWST so as to enable a workflow simulation. GUIs are well known to persons of ordinary skill in the art, who will recognize that an aspect of such interfaces may be multiple equivalent methods of accomplishing the same act, such methods including pointing and clicking on a display object with a computer mouse, dropdown menu boxes, and sequences of keyboard or special function key keystrokes. While only on of these methods is used in the description of this example, the others are equally possible, and whether they are provided in a specific embodiment may depend on the specific use or vendor or customer preferences.

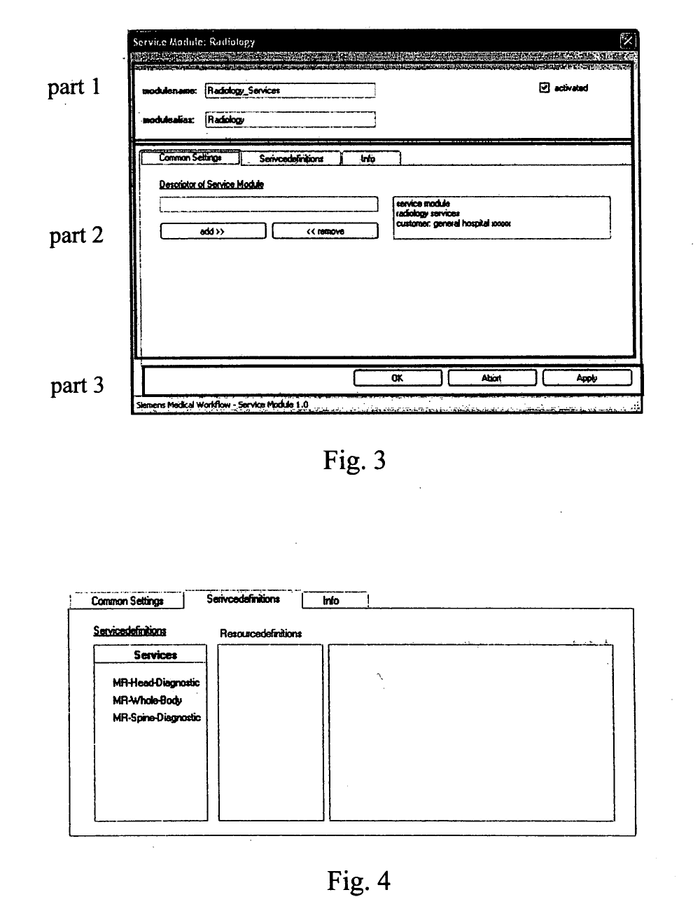

The service module may be divided into three parts. The first part (upper area in FIG. 3) represents common information such as the name of the module and an alias. The alias may be used as the displayed name within the simulation model. An alias may be used as a computer module software may not accommodate blank spaces or special characters in variables. On the right-hand side of the first part, a checkbox is provided so as to indicate whether the service module is currently activated. A non-activated module does not affect the simulation. Therefore, several service module may be inserted into a simulation, and a choice can be made as to which is used. More than one service module may be activated in a simulation. A command bar is also provided.

The second part (center area of FIG. 3) may consist of a tabbed pane which divided into, for example, three single tabs, as shown in FIG. 4. The “Common Settings” tab may be a descriptor which is used to describe the kind of service module. The workflow process may need to provide information used to choose which one of the active service modules should be used as source for, for example, an appointment description (a main aspect of service module). The descriptor may be modified as needed by a modeler, but at least one description is inserted into a module descriptor.

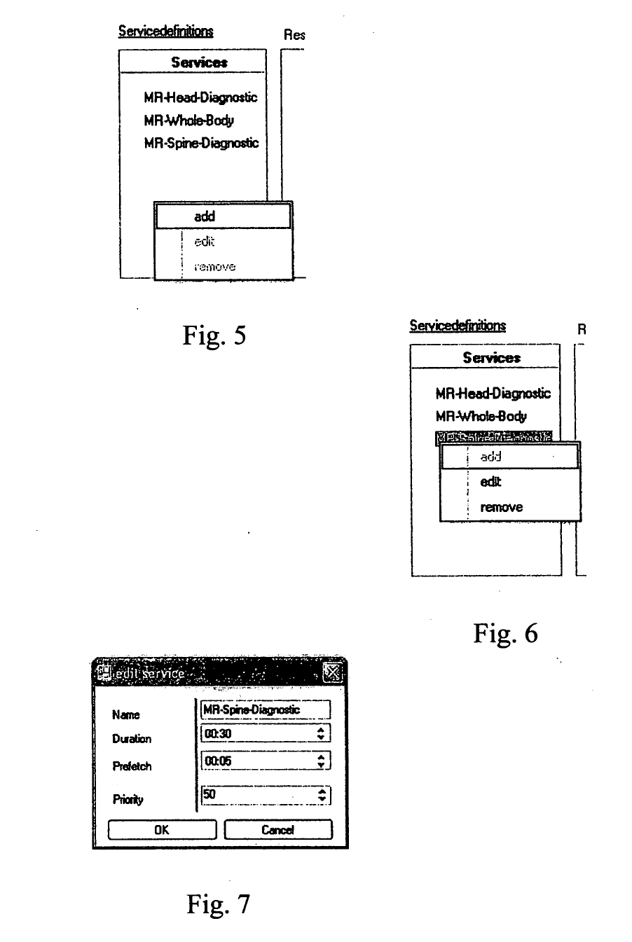

The “Service definitions” tab shows currently defined services, such as “MR-Head-Diagnostic” on the left-hand side. The name of each service is unique, as the workflow processes trigger planning procedures with respect to the service name. There are no restrictions on the characters can be used for service names (including blank spaces). Clicking the right mouse button with a cursor positioned on a free area of the display shows the actions that are permitted: for example, adding a new service definition to the service module (see FIG. 5). Performing the same clicking action on an existing service name displays the options for editing and for removing the main attributes of the service (see FIG. 6). Both options “add” and “edit” lead to the same or similar dialog to add a new service attributes, or edit the currently selected services attributes. An example of the result of this dialog is shown in FIG. 7.

In this example, four attributes may be defined for each service: the name of service, the expected time duration of service; the “pre-fetch” time (time span ahead the start of an appointment for which a patient process should be scheduled to move to functional department (e.g., radiology); and, the priority of the service. The priority of a service may not relate to the order in which scheduled services will be performed. Rather, it may be used to avoid situations where a service may be blocked due to, for example, equipment availability constraints. As an example, an electrocardiogram service requires a room where all of the needed equipment resides. Perhaps all of the equipment is available in an operating room. To avoid having the electrocardiogram service blocking the availability of an operating room, each room has an attached priority. Only if the priority of a service is greater than the priority of the room will the room will be considered as possible location for performing the service.

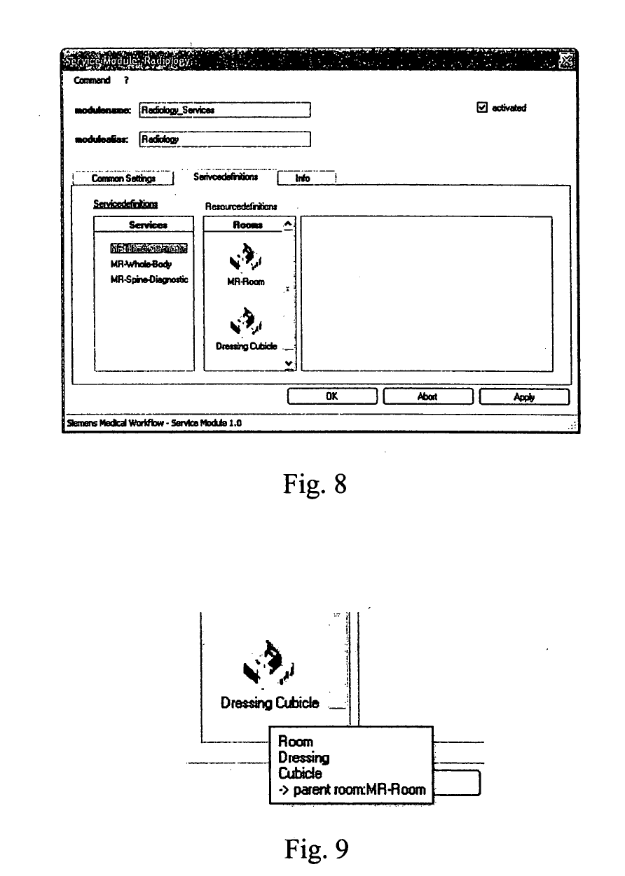

The screen of FIG. 8 will be displayed if a service is selected, for example, by a mouse click on a service name. All of the defined rooms for the selected service are visible. Each of the rooms may be shown with a small symbol or icon, and a name. Each of the rooms is given a separate name. In a GUI, moving the mouse pointer onto one of the room definitions causes a small tooltip to appear (see FIG. 9). The tooltip displays a shortened overview of the resource descriptor and may display additional state information. The state information is marked indicated “->” in front of each entry. State information may be available for two kinds of resources: rooms and devices.

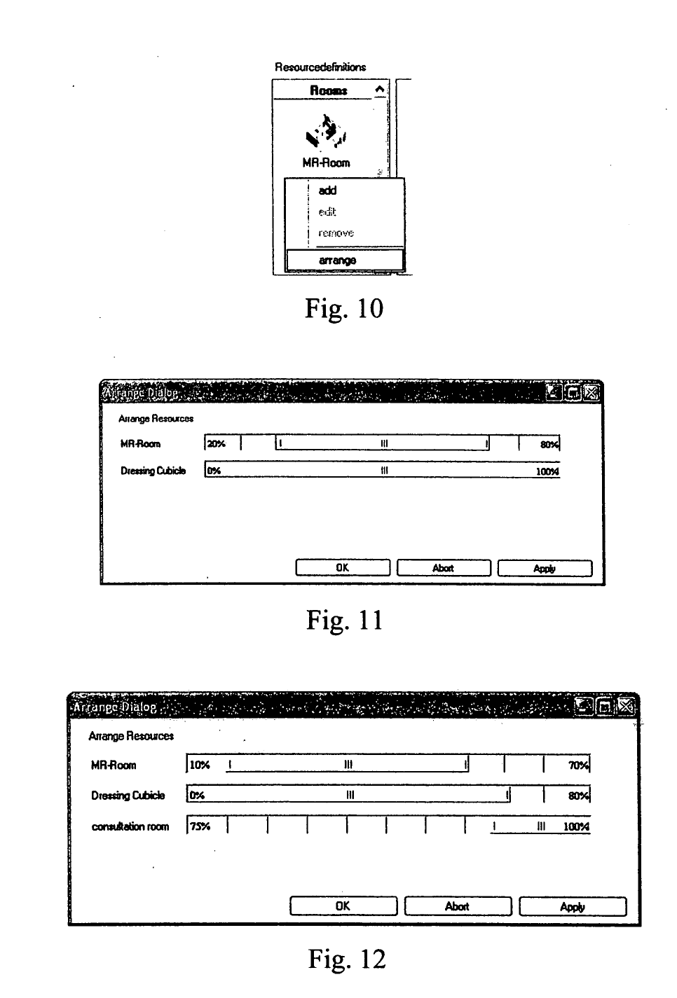

The view, for rooms of a service, may have the same context menu as in FIGS. 5 and 6, except that an “arrange” menu entry is added, as shown in FIG. 10. Selecting the “arrange” command will cause another dialog cause to open (see FIG. 11).

The “arrange” function is intended to provide for an option of determining if a room is needed for the duration of a service or only for some portion thereof. For each room a separate range bar may appear, which may be adjustable to indicate when a resource is needed in the procedure model. The start point and end point may be given as a percentage of the service duration. For example, if the duration of a service (such as that in FIG. 7) is 30 minutes, the definition for “MR-Room” shown in FIG. 11 would extend from 6 minutes after start of service (6 minutes being 20% of 30 minutes) to 24 minutes after start of service (24 minutes being 80% of 30 minutes). Defining the usage of a room in this manner permits inclusion of a plurality of rooms into a single service definition, but need not block all of the rooms for whole duration of the service. Rather, serial, parallel, or partial parallel usage definitions may be used, as shown in FIG. 12

Room usage may be normalized according to the overall duration of the service. Usages of other types of resources may be normalized to the actual usage time of the room in which the resources reside. The service module stores percentages and the scheduling module performs the function of interpreting the percentages. Different scheduling modules may therefore have different perspectives. One scheduling module may see the percentages of resources as normalized according to the room in which the service is being performed, while other scheduling modules may interpret the percentages with respect to overall service time. This is the reason why the process module (patient process) decides which service module and which scheduling module to use to search for an optimized target date for a service.

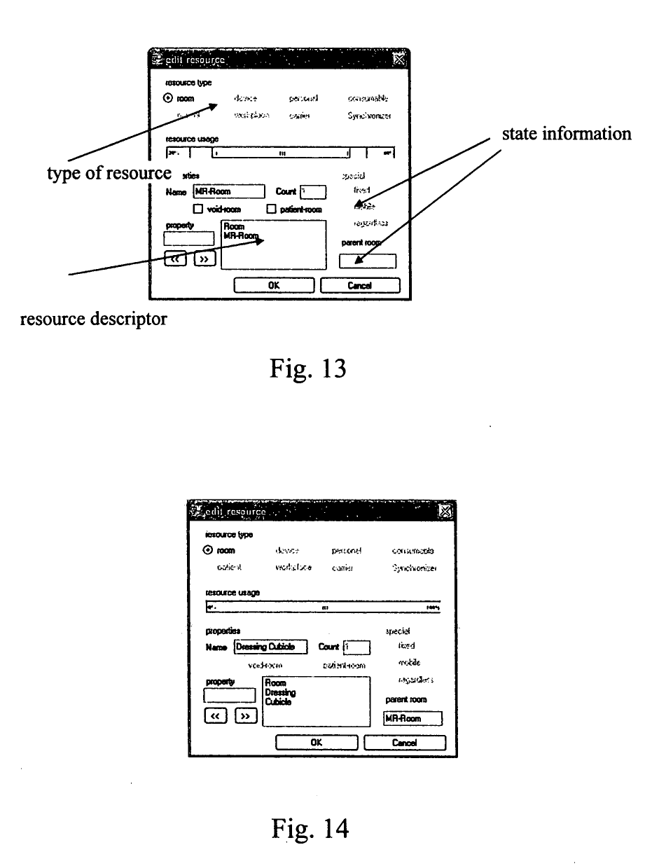

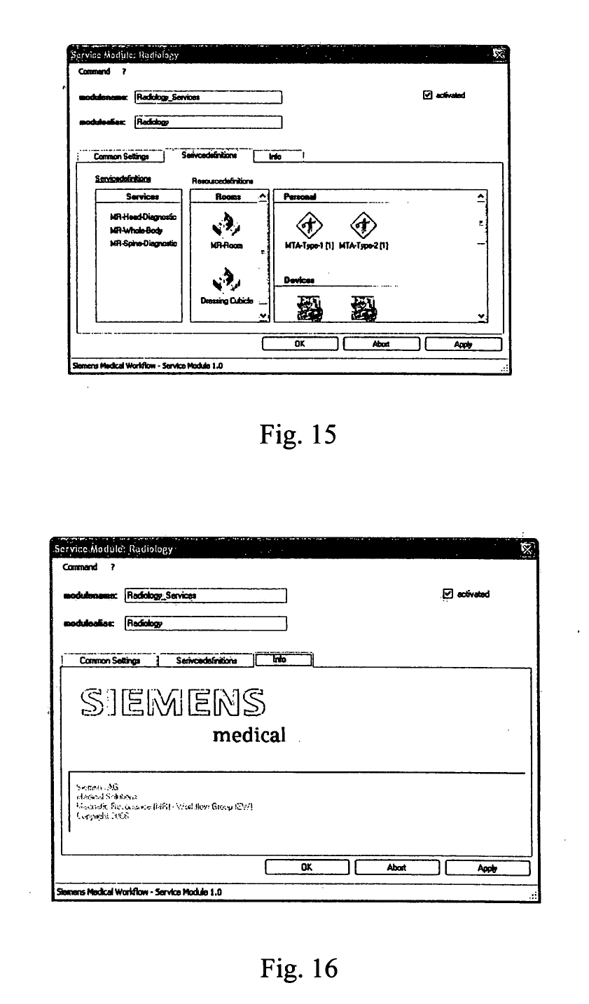

By moving the mouse pointer over the symbol of a room definition and opening the context menu with right mouse click, for example, a new room may added, edited or removed. When choosing an “edit” or “add” command, a dialog such as shown in FIG. 13 may be used.

This dialog interface demonstrates that a variety of potential configurations may be created. In this example, the resources are clustered into eight different classes: rooms, devices, personnel, consumables, patient, workplace, carrier and synchronizer. In editing or adding a new room the resource type is not changed. In all other cases the resource type may be changed, except that a non room resource may not be changed into a room resource. Depending on which type of resource is selected, there may be a plurality of configurations available.

In some cases, certain selections may not be permitted for logical or practical reasons. Rooms are selected individually, so that if two rooms with identical requirements are needed, they are defined as being two separate rooms. Two different room types are provided in this example: a fictive or “void-room” and a “patient room”. Whereas a “patient room” is self-explanatory, a “void-room” means that a physical room will not be allocated for this room description. This construct may be used to define resources (e.g. personnel) which are not bound to a special room.

Resources are used for the time the room which contains the resources is used. Thus a resource (e.g. personnel or mobile device) which is used at different locations within one service may be defined as being in a void-room. Only one room within a service definition is the “void-room”.

Another configuration possibility is to define a parent room for a room resource. A parent room may constrain the set of possible rooms for a room definition. For example, a MR-Room may have two dressing cubicles communicating thereto. Altogether, for three MR-Rooms having the same configuration, and there would be six possible dressing cubicles. However, with respect to one of the MR-Rooms, not all six dressing cubicles are suitable for the definition of a dressing cubicle for that service. Only the two dressing cubicles which are associated with the chosen MR-Room are suitable Defining a dressing cubicle to have an MR-Room as its parent, express this kind of relationship, as shown in FIG. 14.

Defining a parent room may automatically disable the “void-room” and the “patient-room” options. That is, a parent room is defined if neither “void-room” nor “patient-room” are chosen. This concept requires that each modeled room in a simulation has some knowledge about associated rooms.

By clicking with left mouse button, for example, on a room definition, the resource control is filled with the resource definition for that room. It is not necessary to place any resources in a room definition, whereas a service contains at least one room. As shown in FIG. 14, each resource type has an identification symbol or icon, and annotated name. A unique name is used for each specific differentiable resource for identification. In addition, each resource name is followed by the number of resources of that kind needed, in brackets.

The right-hand-side of the control panel displays icons, resource names and quantities of each inside the currently selected room within currently selected service. The same or similar control functionality as the central portion of the control panel is provided (e.g. tooltip, add, edit, remove, arrange).

The last of the three tab pages (FIG. 16) may be an information page. It may show, for example, the vendor and some additional information about the service module.

The service module may interact with other CWST modules such as a scheduler, a personnel manager, a device manager, an inventory list. The scheduler module may search for and provide an optimized target date and perhaps time for the patient appointment. The personnel manager contains details of staff availability and skills. The device manager contains details of each identified device. Generally the devices are associated with rooms and a schedule of device availability taking account of previous device and room commitments, preventive maintenance, cleaning and the like. Each room also has an associated inventory list. These modules, in conjunction with the CWST, may be used to optimize a workflow associated with the operation of a hospital or unit thereof.

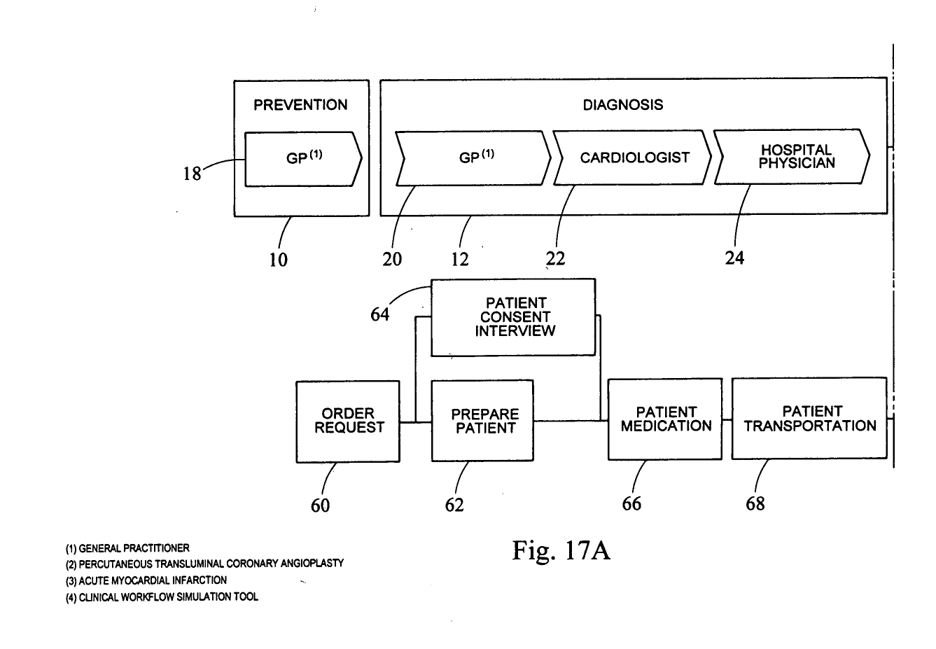

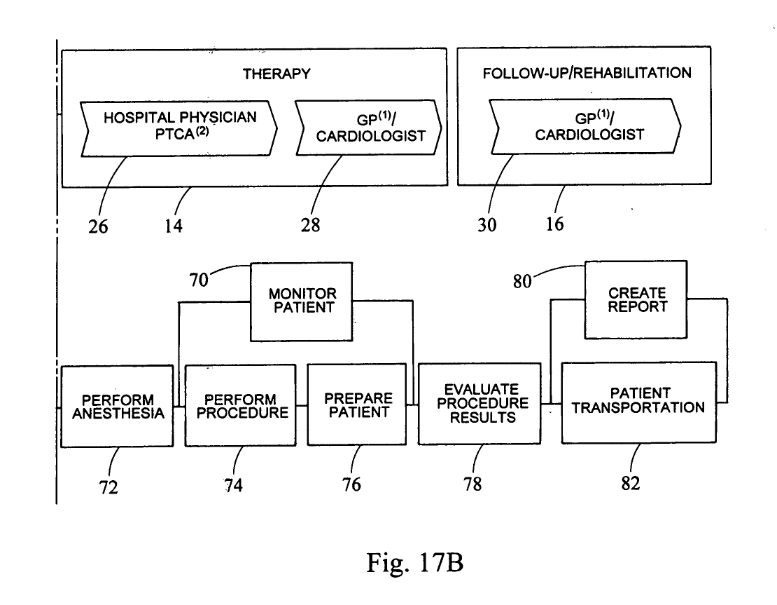

Once the modules are established and arranged according to the facility workflow as indicated in FIG. 17, the set of modules is transferred to the clinical workflow simulation tool. The workflow simulation tool is run as a simulated process as shown in FIG. 17. The major steps 10-16 and sub-processes 18-30 indicated in FIGS. 1 and 2 are indicated in the upper portions of FIG. 17. The detailed modules which constitute the hospital physician PTCA step are indicated in the illustrated example as including the order request module 60, the patient interview and consent module 64, the prepared patient module 62, the patient medication module 66, the patient transportation module 68, the perform anesthesia module 72, the monitor patient module 70, the perform procedure module 74, the prepare patient module 76, the evaluate procedure results module 78, the create report module 80, and the patient transportation module 82.

In running the simulation, the actors for each module, the location in the healthcare facility and other factors, many of which are specific to the healthcare facility, are taken into account. The simulation not only involves simulating a single workflow but also simulating workflows of other processes taking place at the healthcare facility so that interactions between workflows is simulated.

Once the clinical workflow is modeled in the system, it is now possible to measure parameters within the workflow. Relevant parameters based on clinical, operational or financial questions can be defined in the healthcare facility workflow. Various questions can be answered and variations in parameters are possible.

The instructions may be stored on a removable media device for reading by local or remote systems. In other embodiments, the instructions may be stored in a remote location for transfer through a computer network, a local or wide area network, by wireless techniques, or over telephone lines. In yet other embodiments, the instructions are stored within a given computer, system, or device.

Although only a few examples of this invention have been described in detail above, those skilled in the art will readily appreciate that many modifications are possible without materially departing from the novel teachings and advantages of the invention. Accordingly, all such modifications are intended to be included within the scope of this invention as defined in the following claims.

What is claimed is:

1. A service module for a workflow simulation tool for a healthcare facility, comprising:
software stored on a computer readable medium and operable on a computer to perform the following steps:
providing a graphical user interface (GUI); and
accepting user input through the GUI for defining the parameters and states of an object representing resources in a health care facility,
wherein the object is associated with a workflow process step.

2. The service module of claim 1, wherein the parameters and states of the object is accessible by other modules of a workflow simulator.

3. The service module of claim 1, wherein a service module may be stored in an active or an inactive state.

4. The service module of claim 1, wherein the service module contains attributes for one or more individual services, the attributes including a name of the service, a time duration of the service, a patient availability lead time, and a priority.

5. The service module of claim 4, wherein the service module specifies the time interval during the process step when the room is required.

6. The service module of claim 4, wherein an individual service is associated with at least one room description and at least one of the room descriptions is a patient room.

7. The service module of claim 6, wherein one of the room descriptions is a void room which identifies at least one of personnel, equipment, or consumables associated with the service.

8. The service module of claim 1, wherein resources are grouped as two or more of rooms, devices, personnel, consumables, or patient.

9. A method for using a service module in workflow simulation in a healthcare facility, comprising the steps of
inputting data characterizing a service, the data including a name of the service, duration of the service, priority of the service, and resources required;
storing the data in a memory; and
providing the data to a requesting module in a workflow simulation.

10. The method of claim 9, wherein the requesting module is a personnel manager module, a device manager module, a scheduler module, or an inventory module.

11. The method of claim 9, wherein the resources are clustered by similarity of class.

12. The method of claim 11, wherein resources are clustered into two or more of rooms, personnel, equipment, or consumables.

13. The method of claim 11, wherein a time of use duration of physical resources is normalized to a service time duration.

14. The method of claim 13, wherein a time duration of availability of personnel is normalized to the time of use duration of the physical resource.
